(19) United States
(12) Patent Application Publication
(10) Pub. No.: US 2007/0271133 A1
(43) Pub. Date: Nov. 22, 2007

(54) Pay-Per-Day Online Advertising System

(76) Inventor: Lawrence Thomas McElhinney, Cocoa Beach, FL (US)

Correspondence Address: Lawrence Thomas McElhinney Jr., 3501 Silverside Road, 206 Naamans Building, Wilmington, DE, 19810, US

(21) Appl. No.: 11/383,535

(22) Filed: May 16, 2006

(51) Int. Cl. G06Q 30/00

(52) U.S. Cl. 705/14

(57) ABSTRACT

A method and system that allows advertisers to bid for favorable placement of their ads relative to other advertisers, over a given time period and at a fixed cost. The provider of said system solicits ads from advertisers via an electronic interface. The advertisers provide ad copy, indicate how much they are willing to spend (ad price) for a given time period and then submit this information to the provider's servers. The ads appear, sorted by ad price, when potential customers submit search engine queries against a database of information which includes, but is not necessarily limited to, the ad copy submitted by the advertisers. Unlike pay-per-click or other pay-per-[action] systems, this invention is immune to click fraud and other types of end user fraud including automated fraud.

### BACKGROUND OF THE INVENTION

This invention relates to Internet advertising. More specifically, it describes an online advertising system that offers substantial advantages over existing online advertising systems.

The most popular form of online advertising is called pay-per-click. Pay-per-click advertising systems have been commercially available for a number of years. Service providers include such companies as Yahoo, Google, MSN, Miva and many more. Pay-per-click advertising allows Internet merchants to advertise their websites and/or products and services via a results page which is generated by a search engine after the user issues a query. Stated another way, the user enters a keyword and then the search engine displays a page of results (a.k.a. listings). Some of these listings are paid for by advertisers (a.k.a. sponsors) on a pay-per-click basis. This means that if a user clicks on a ‘sponsored listing’, the service provider charges the advertiser for that click. The advertisers bid on search terms such as ‘Real Estate Broker’. If a user enters this search term the advertisers that have bid on this term will have their listings appear on the result page(s) with their ads ranked based upon one or more factors. Typically ads are ranked in descending order based on bid price but some systems such as Google use other factors as well.

In most pay-per-click systems, the advertiser pays only for clicks. In other words, if an advertiser's listing appears within a set of results, the service provider charges the advertiser only if the user clicks on that particular listing. Most if not all of these pay-per-click systems have two major problems. The first problem is ‘click abuse’. Click abuse (a.k.a. click fraud) is defined as any click (upon a sponsored listing) that is generated by a party or entity with the sole intent of charging the advertiser thereby compromising the integrity of the system. The abuser has no interest or intention of using the advertiser's products or services. Click fraud can be caused by users or by automated systems. Service providers attempt to address the problem of click fraud by telling advertisers that they have created a system which filters out fraudulent clicks. But how could any filtering system know for sure what a user's true intentions are? This ability is beyond the scope of current technology. One must also realize that programmers will continue to develop fraudulent clicking systems to overcome the filtering systems designed by the pay-per-click service providers. Therefore, the service provider is continuously fighting click fraud and the advertiser is continuously suspicious of click fraud. The filtering systems also add overhead to the system as a whole.

The second problem with pay-per-click is that the advertiser cannot fix the costs of his advertising while simultaneously fixing the display persistence of his/her advertising. In other words you can tell a pay-per-click system to serve up your listing for a given period of time without interruption OR you can tell the system to cap your costs at a certain dollar amount. But you cannot do both simultaneously. The examples below demonstrate this fact.

### EXAMPLE 1

If an advertiser wants his pay-per-click service provider to serve up his listing continuously for 72 hours for the search term ‘Real Estate Broker’, said advertiser must accept the fact that his costs have no defined limit.

### EXAMPLE 2

If an advertiser wants to cap his costs at $100, said advertiser must accept the fact, that his listing will not be served up once his spending cap has been reached.

Therefore a pay-per-click advertiser must choose between fixed cost advertising OR the peace of mind of knowing that his target audience can find him via a particular pay-per-click service at all times. The pay-per-click advertiser cannot have both of these luxuries simultaneously.

A variation of the pay-per-click system is called pay-per-call. In a pay-per-call system, the sponsored listings contain phone numbers. The advertiser is charged only if the user calls the phone number contained in the advertisement. This system has problems similar to those of the pay-per-click system. Instead of click abuse for example, advertisers and service providers struggle against ‘call abuse’. Call abuse can be caused by a user or by an automated system. Filtering systems designed to stop call abuse add overhead to the overall system. As with pay-per-click, the pay-per-call advertiser does not have the luxury of telling the system to serve up his listing for a given period of time while simultaneously capping his costs.

### SUMMARY OF THE INVENTION

The present invention solves the problems of the prior art in a number of ways. First and foremost, the present invention allows the advertiser to cap the costs of his advertising while simultaneously specifying the display persistence of his advertisements. To do this, the advertiser chooses an Ad Price. The advertiser is informed by the system that his Ad Price covers a given time period (i.e. one day) and will stay in effect until he changes it. The time period could be any fixed length of time. The examples below use a time period of one day and thus the system in the example is called ‘pay-per-day’.

### EXAMPLE 1

In a pay-per-day system, an advertiser would enter a search term (or a list of terms) and would then specify how much he is willing to pay to have his listing displayed for the entire day. Now, whenever a user enters a search term(s) specified by the advertiser (ie. the user submits a search engine query), the advertiser's listing will appear on the results page and will be ranked against other listings based upon Ad Price (a.k.a. bid price) and possibly other factors.

### EXAMPLE 2

In a pay-per-day system, the advertiser enters a text based advertisement. The advertiser then tells the system how much she is willing to pay to have her listing displayed for the entire day whenever a user enters any of the words contained in her advertisement. When displayed, the advertiser's listing will be ranked against other listings based upon Ad Price (a.k.a. bid price) and possibly other factors.

These examples would work in a similar fashion for a pay-per-week, pay-per-month or pay-per-[anytime period] model. A working model of a pay-per-day system can be found at https://www.superlinks.com/advertiser/signup.cfm.

Another advantage of the present invention is that there is no possibility of click fraud because the advertiser is not charged for clicks. The substantial additional expense to the vendor of developing and continually adjusting click fraud filtration systems is therefore eliminated. Both the vendor and the advertiser have no click fraud concerns with the present invention.

The experience for the end user (ie, the person issuing the query) is essentially the same in the present invention as compared to the end user experience in a pay-per-click search engine website. The end user enters a search term and then clicks a submit or ‘Search’ button to submit the query. The system connects to its database of listings and then displays the results. The sponsored listings are displayed in a ranked order based upon Ad Price or some combination of factors that include Ad Price. Sponsored results are typically displayed in an area of the computer screen that is separated from the non-sponsored results but not necessarily.

### BRIEF DESCRIPTION OF THE DRAWINGS

FIG. 1 is the initial promotional screen for new advertisers as well as the login screen for existing advertisers.

FIG. 2 shows the first step a new advertiser must complete to initiate his account.

FIG. 3 shows the second step a new advertiser must complete to initiate his account.

FIG. 4 shows the third and final step a new advertiser must complete to initiate his account.

FIG. 5 shows the screen that allows the advertiser to view and change the settings for his/her account.

FIG. 6 shows the query mechanism that allows the user to view competitive bidding information for a given search term.

FIG. 7 shows the Terms of Service that the advertiser would agree to prior to creating his account.

FIG. 8 shows a query submitted by an end user interested in the subject of ‘link exchange’.

### DESCRIPTION OF THE SPECIFIC EMBODIMENTS

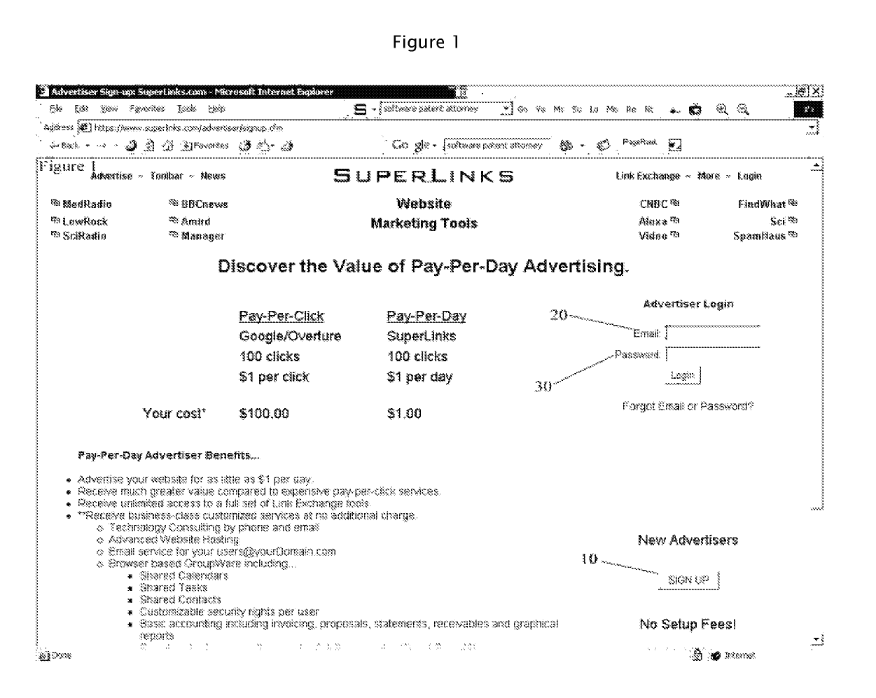

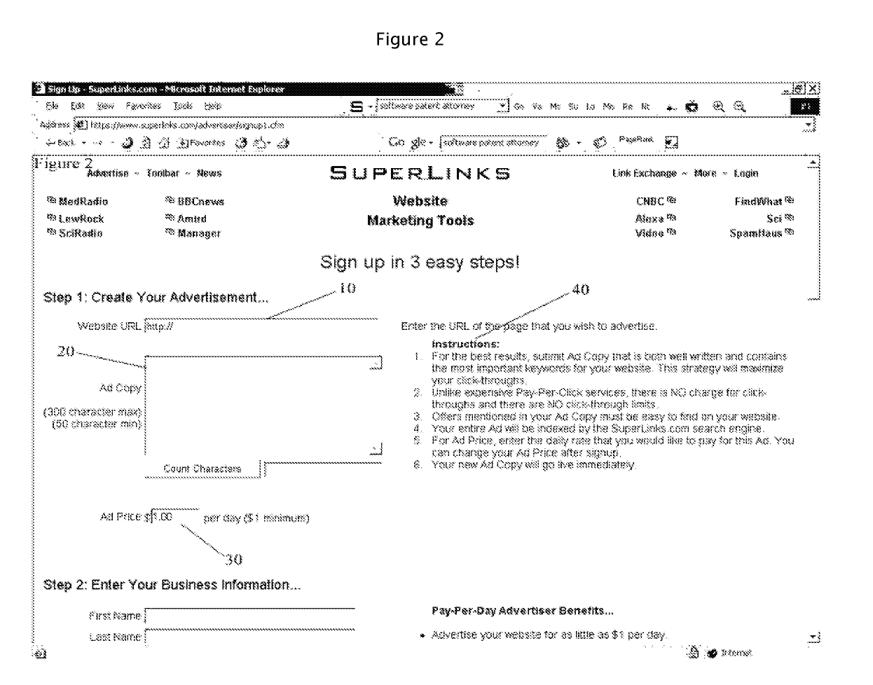

Referring to FIG. 1, after reading the promotional information about the ‘Pay-per-day’ system, an new advertiser would click on the ‘SIGNUP’ button 10 which takes him to a signup page shown in FIG. 2. An existing advertiser would use the email box 20 and the password box 30 of FIG. 1, to login to his account.

In FIG. 2, the new advertiser would enter the URL of his website in box 10, his Ad Copy in box 20 and his Ad Price in box 30 after reading the instructions 40.

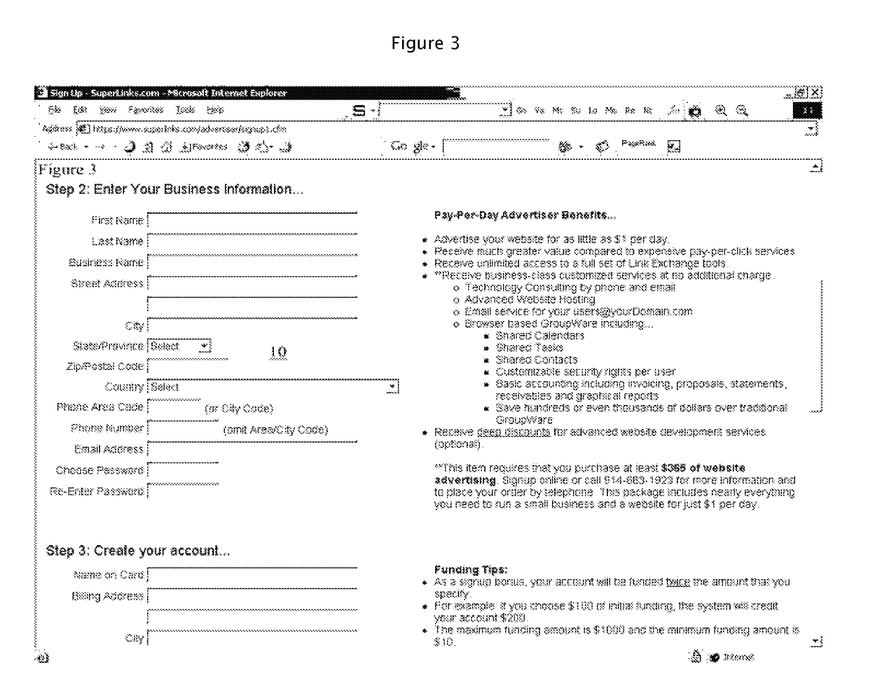

In FIG. 3, the new advertiser would enter his business information in the boxes provided in area 10.

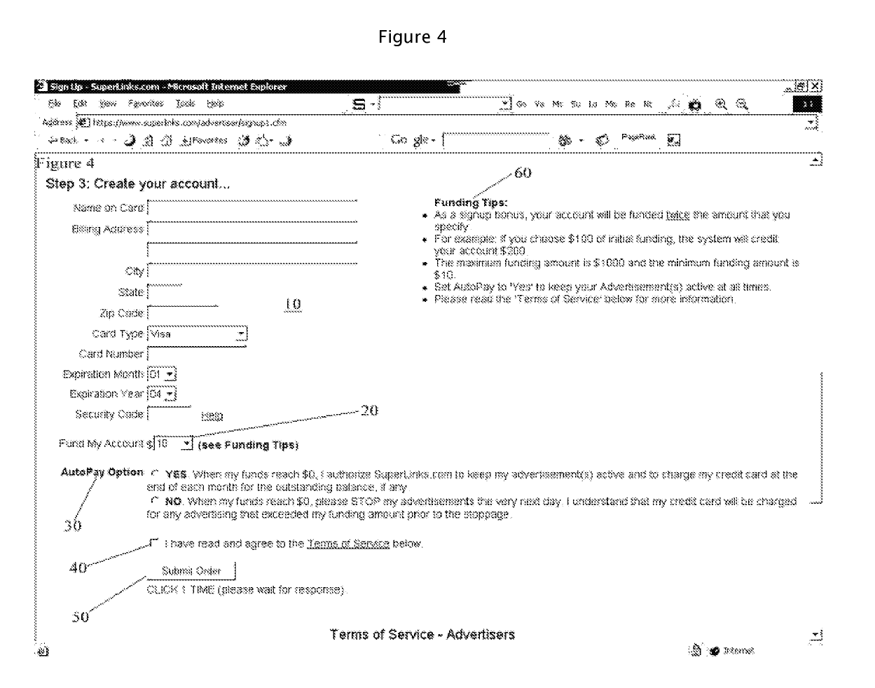

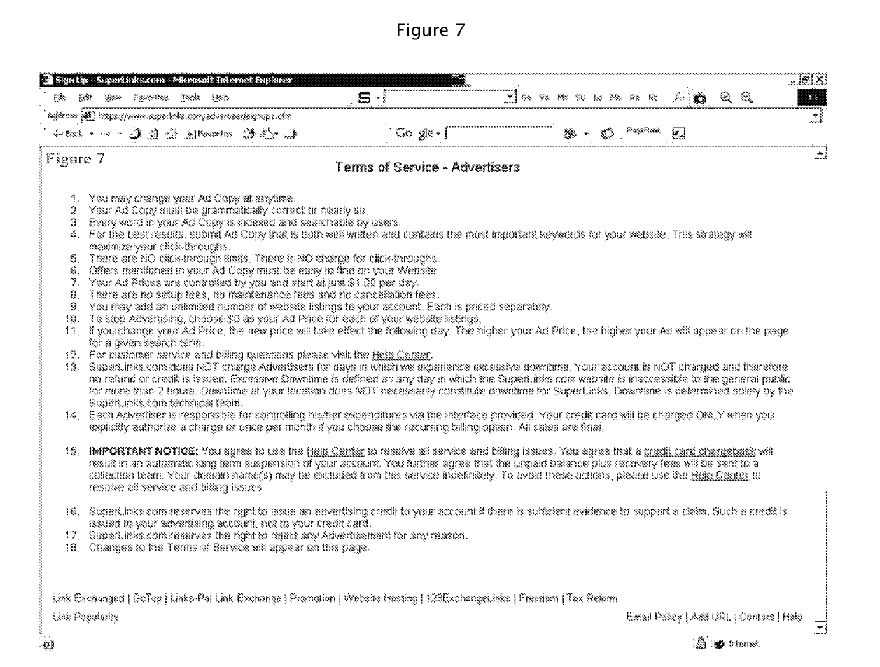

In FIG. 4, the new advertiser would enter his billing and credit card information in the boxes provided in area 10. Also in FIG. 4, the new advertiser may choose to fund his account a certain number of dollars after reading the funding tips 60. Also in FIG. 4, the new advertiser would choose an AutoPay option as per the provided instructions 30. Also in FIG. 4, the new advertiser would agree to the Terms of Service 40 as shown in FIG. 7. The Terms of Service could vary based upon the various implementations of the present invention. Also in FIG. 4, the new advertiser would create his new account by clicking the Submit Order button 50.

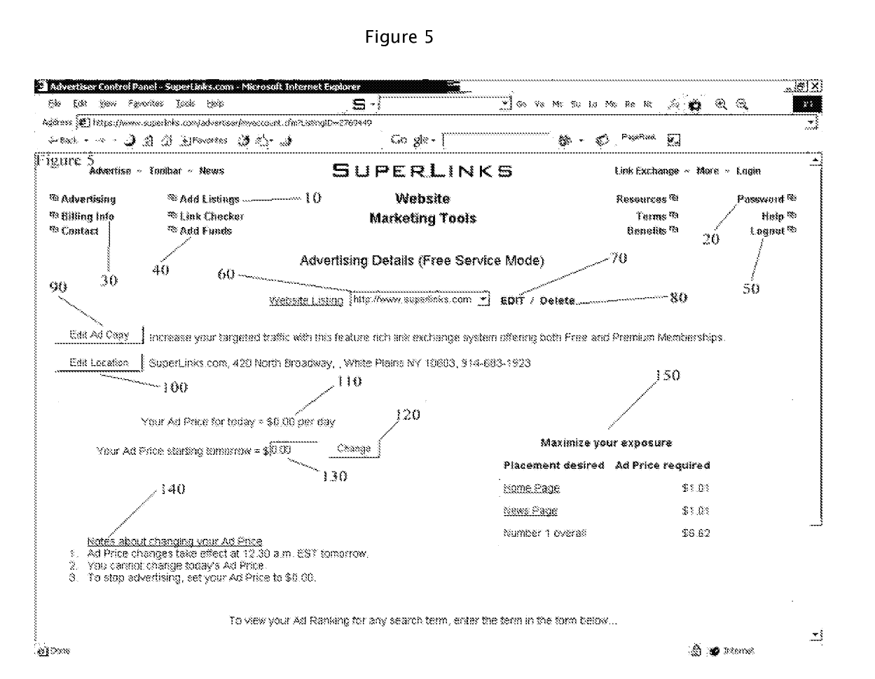

After submitting his order, the advertiser is taken to his control panel shown in FIG. 5. To add an additional website listing(s), the advertiser would click ‘Add Listings’ 10. To change his password the advertiser would click ‘Password’ 20. To view his billing information including current balance, the advertiser would click ‘Billing Info’ 30. To add funds to his account, the advertiser would click ‘Add Funds’ 40. To logout of the system, the advertiser would click ‘Logout’ 50. The advertiser's website listings are contained in the drop down list 60. An advertiser may have one or more website listings with separate Ad Copy, Ad Prices and settings for each. To edit the displayed listing, the advertiser would click ‘Edit’ 70. To delete the displayed listing, the advertiser would click ‘Delete’ 80. To edit the Ad Copy for the displayed listing the advertiser would click ‘Edit Ad Copy’ 90. To edit the business address for the current listing, the advertiser would click ‘Edit Location’ 100. The Ad Price for the current listing 110 can be changed by entering a new price in box 130 and then clicking ‘Change’ 120, after reading the notes 140. The advertiser is encouraged to maximize the exposure for his Ad in chart 150.

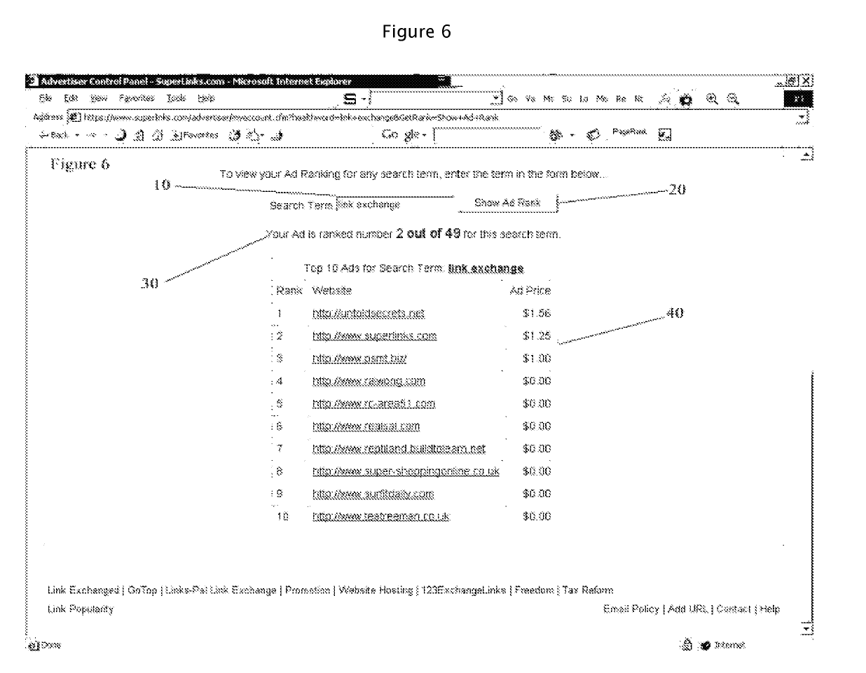

In FIG. 6, the advertiser can enter a search term in box 10 and then click ‘Show Ad Rank’ 20 in order to see how his listings ranks against other listings for the same search term as expressed in item 30 and shown in chart 40.

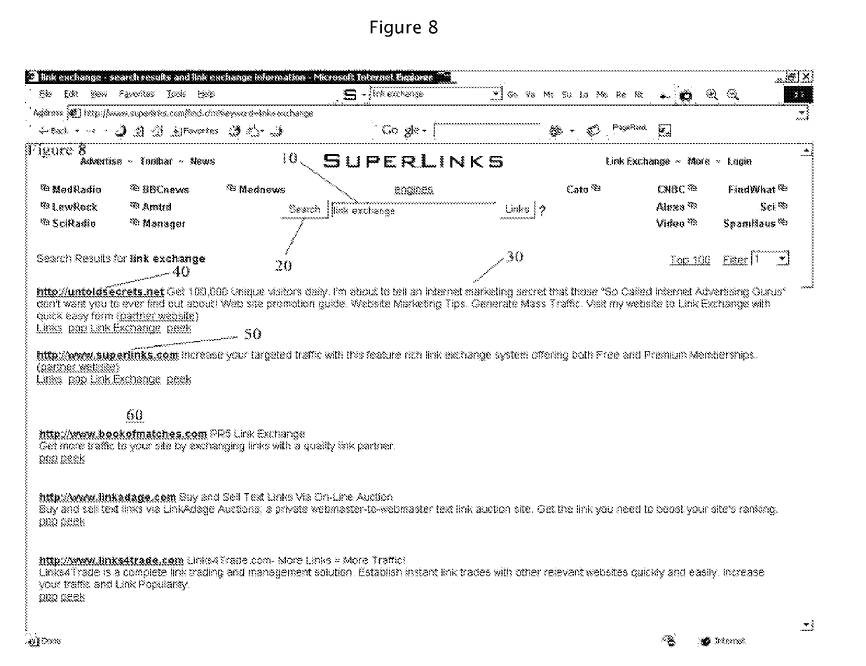

In FIG. 8, the end user, has entered the search term ‘link exchange’ in box 10. The end user submitted the query by clicking ‘Search’ 20. The backend programming has run a query of the backend database and then displayed two sponsored listings in area 30 and non sponsored listings in area 60. The sponsored listing which contains the search term ‘link exchange’ and the highest Ad Price is displayed first 40. A second sponsored listing 50 also containing the search term ‘link exchange’ is displayed under the first listing because its Ad Price is less than that of the first listing. The end user can now click on any listing(s) that he chooses in order to visit those websites. The advertisers are not charged for these clicks.

1. A system enabling advertisers to bid for favorable placement of their ads relative to other: advertisers over a given time period and at a fixed cost set by each advertiser, said system residing on a network and/or available via the Internet, an agent managing said system, said agent's server providing an interface whereby said advertiser can submit his advertisement copy and advertisement price for a given time period, said advertisements being display by said system sorted by ad price alone or together with other variables in response to queries submitted by potential customers or other users against a database of information residing on said server, said database information consisting of the ad copy submitted by the advertisers alone or along with other information.
